(19) United States
(12) Patent Application Publication
(10) Pub. No.: US 2020/0227902 A1
(43) Pub. Date: Jul. 16, 2020

(54) DIRECT COVERPLATE

(71) Applicant: Alltrade Tools LLC, Cypress, CA (US)

(72) Inventor: Hector R. Hernandez, JR., Fullerton, CA (US)

(73) Assignee: Alltrade Tools LLC, Cypress, CA (US)

(21) Appl. No.: 16/245,835

(22) Filed: Jan. 11, 2019

(51) Int. Cl. H02G 3/14; H01R 13/447; H01R 13/717; H05B 33/08

(52) U.S. Cl. CPC H02G 3/14; H01R 13/447; H05B 37/0227; H05B 33/0854; H01R 13/7175

(57) ABSTRACT

An active coverplate comprising a face plate having a proximal surface and a distal surface. An electrical load is included. A flange extends distally away from the face plate, wherein the flange comprises a contact having a distalmost end. The flange further includes a housing defining a hollow interior and sized to receive the contact such that the distalmost end is exposed outside the housing for making electrical contact with a power supply of a receptacle body. The contact is free to slide distally and, alternatingly, proximally within the housing. There is an electrical connection between the contact and the electrical load.

### BACKGROUND

Electric power outlets are commonly provided on a wall of a building structure. A switch may be attached to the power outlet permitting a user to complete a circuit through the power outlet to switch on a light, or other appliance. Alternatively, the power outlet may provide a connection socket to permit a user to insert the terminals of a power driven appliance such as a heater, cooler, kitchen appliance, or the like. Typically, such power outlets are covered by a coverplate, protecting the power supply on the wall from accidental human contact, and thus providing a safety feature.

In recent years, it has become a common feature of a coverplate to provide a function in addition to its safety feature. The coverplate may be provided with two terminals that extend rearwardly from the coverplate, configured to make contact with the two electrically live power terminals on the power outlet, thereby drawing a small amount of current to power small low power devices that are attached to the rear side of the coverplate. Such coverplates are known in the art as active coverplates. It is known that most power outlets have a standard dimension, so that the distance of separation of power terminals on a standard power outlet are known, and this distance of separation is also given to the rearwardly extending terminals on the coverplate so that the rearwardly extending terminals may conveniently contact the power terminals on the outlet. Such low power devices may include features such as LEDs to provide floor lighting, or LEDs to provide an indication whether the power through the outlet is on or off. These LEDs may further be controlled by switches such as motion detector switches, or photosensor switches. Other features include USB charging ports, and the like.

However, a problem in the prior art arises during the manufacture and assembly of such coverplates, and this problem during assembly may extend to the safety of the resulting coverplate once it is manufactured and assembled. During assembly, the complexity of assembling a fairly complex electric circuit onto the back of a coverplate is made difficult by the fact that numerous components and elements must be connected to the coverplate, thus giving rise to the potential for assembly error. As a result, the eventual product may present the consumer public with a product that is not sufficiently safe for installation onto power outlets that are powered by live electricity.

Another problem encountered in the prior art is that the clips or prongs provided by standard powered coverplates tend to be lengthy in order to reach the screws on a power receptacle, and these may come in contact with the wall box or other conductive material, which often will be metal. This is an ongoing problem, and large manufacturing costs are incurred in trying to reduce this problem.

The present invention addresses these and other needs.

### SUMMARY OF THE INVENTION

In one embodiment, the invention is an active coverplate comprising a face plate having a proximal surface and a distal surface and an electrical load. A flange extends distally away from the distal surface of the face plate. The flange comprises a contact having a distalmost end. It includes a housing defining a hollow interior and sized to receive the contact such that the distalmost end is exposed outside the housing for making electrical contact with a power supply of a receptacle body. The contact is free to slide distally and, alternatingly, proximally within the housing. The coverplate also includes an electrical connection between the contact and the electrical load.

In some embodiments, a spring is positioned in the housing to bias the contact distally. In other embodiments, the contact is a hollow cylinder, and the spring is positioned within the cylinder.

In some embodiments, the coverplate includes a support frame attachable to the distal surface of the face plate, wherein the flange is a molded feature of the support frame.

These and further advantages will be more fully apparent when read in light of the drawings and the detailed description of some embodiments.

### BRIEF DESCRIPTION OF THE DRAWINGS

FIG. 1 is a front elevational view of a coverplate having features of the invention shown mounted on an electrical outlet.

FIG. 2 is a rear perspective view of the coverplate shown in FIG. 1.

FIG. 3 is a rear view of the coverplate shown in FIG. 1.

FIG. 4 is a rear perspective view of the coverplate of FIG. 1 in a state of partial disassembly.

FIG. 5 is a front view of a power outlet receptacle known in the art.

FIG. 6 is a side view of the power outlet of FIG. 5.

FIG. 7 is detail rear view of an aspect of the coverplate shown in FIG. 1.

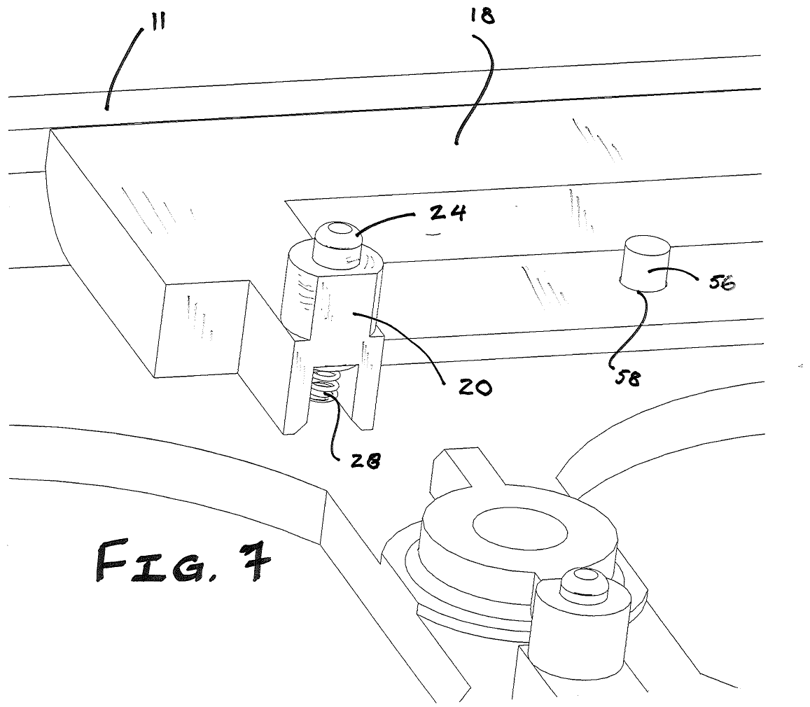

FIG. 8 is a rear perspective view of the coverplate shown in FIG. 1, shown attached to a standard power outlet receptacle.

FIG. 9 shows a detail sectional view taken substantially along the line A-A in FIG. 3.

### DETAILED DESCRIPTION OF SOME EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale. In some embodiments, the invention comprises a coverplate configured for attachment to a power outlet on a wall.

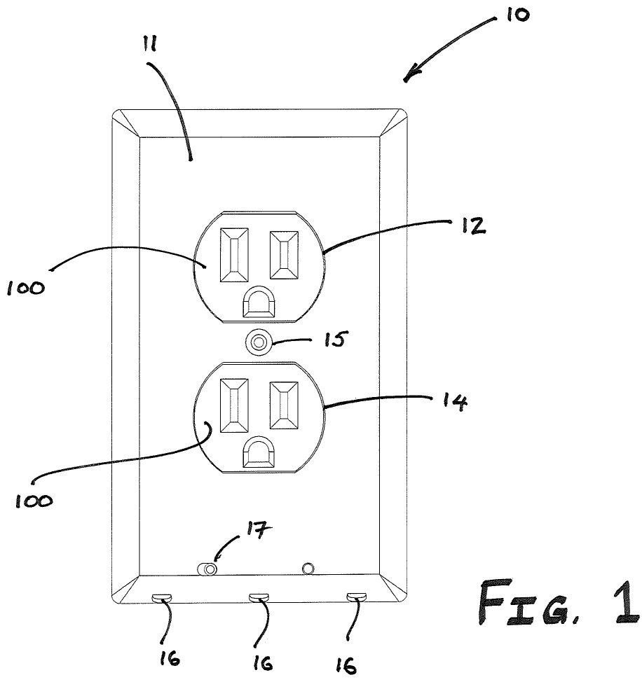

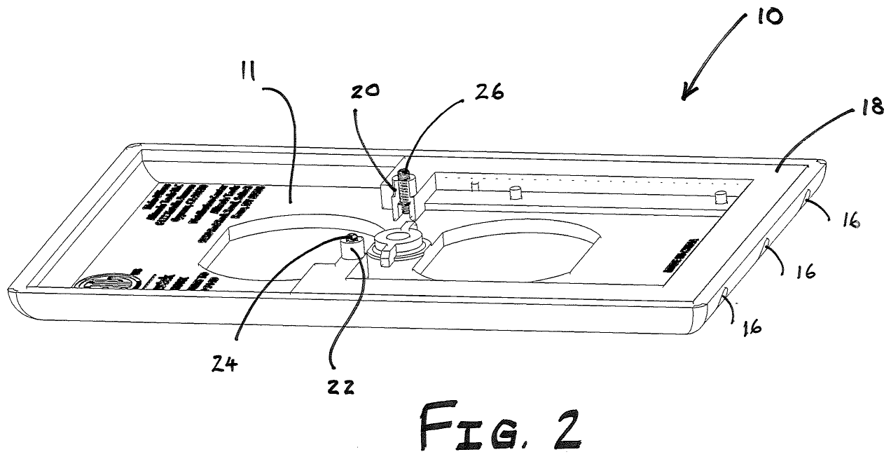

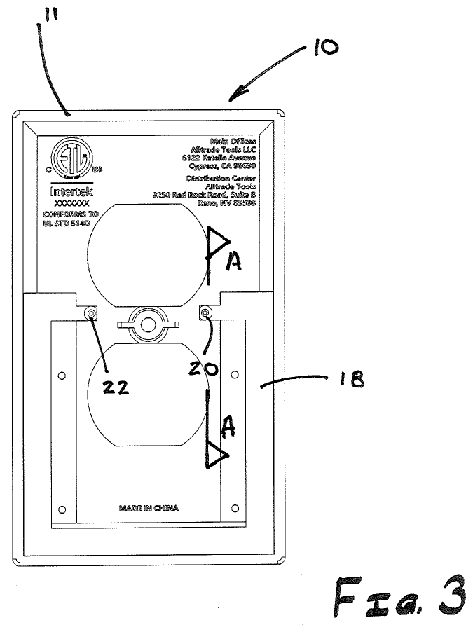

FIGS. 1, 2, and 3 illustrate an example of a coverplate 10 in an assembled condition. FIG. 1 illustrates a front view of the coverplate 10; FIG. 2 illustrates a rear perspective view of the coverplate 10; FIG. 3 illustrates a rear plan view of the coverplate 10. In at least one implementation, the coverplate 10 is configured to be placed over an electrical power outlet installed on a wall. That is, in one of its functions, the coverplate 10 prevents access by human operators to an electrical box containing a power outlet—unless the coverplate is removed.

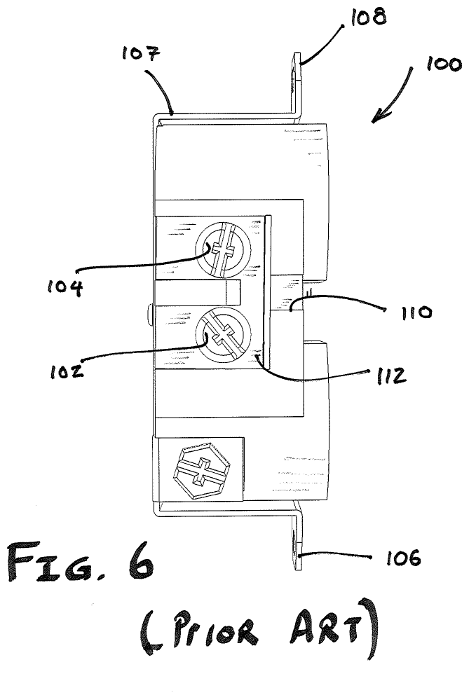

FIGS. 1-3 show that the coverplate 10 includes a faceplate 11 having a proximal surface that faces proximally outwardly, and a distal surface that is covered when the coverplate is installed on a wall box. In at least one implementation, the faceplate 11 can mate with the power outlet to prevent access to the electrical box in which the outlet is mounted. That is, the faceplate can, in combination with the outlet, prevent access to the wires and connections within the electrical box. The faceplate 11 can include an insulating material to prevent electrocution of a user. For example, the faceplate 11 can include plastic. An example of a coverplate 10 connected to an outlet 100 is shown in FIG. 6, so as to close off access from the front to the electrical circuitry in the power supply.

FIGS. 1-3 also show that the coverplate 10 can include one or more apertures 12, 14. In at least one implementation, the one or more apertures can provide access to an outlet 100. That is, the coverplate 10 covers a portion of an outlet but allows access to other portions.

FIGS. 1-3 show that the coverplate 10 can include an attachment 15 such as a screw hole. A screw may be inserted into a bore in the outlet which holds the coverplate 10 in place relative to the outlet.

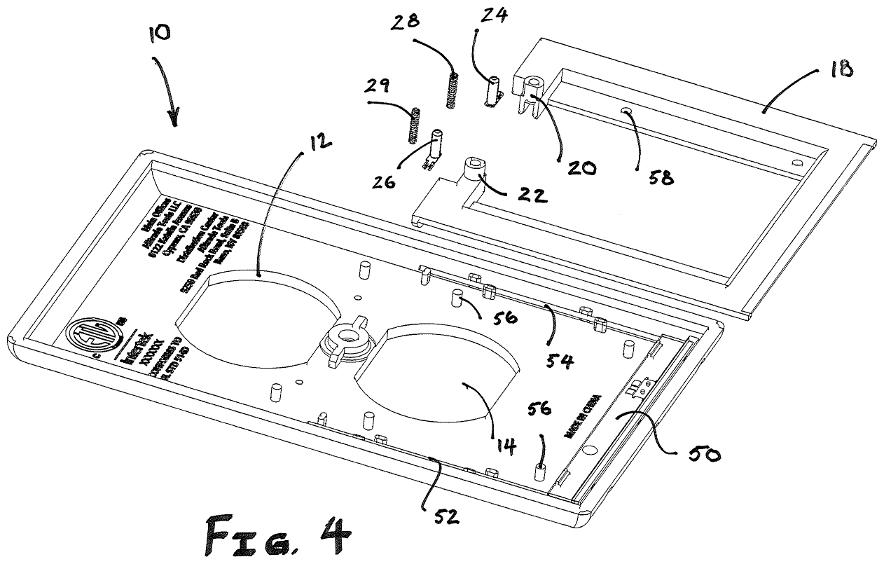

FIG. 4 shows that the coverplate 10 comprises two major separable components namely a support frame 18, and the faceplate 11. The support frame 18 may be advantageously attachable to the faceplate 11. As will be described further herein, the support frame may be configured to receive and carry the majority of all other elements of the coverplate 10 during assembly before the support frame 18 is attached to the faceplate 11. This aspect of the invention provides advantages.

With reference to FIGS. 3 and 4, it is shown that the support frame 18 may assume the shape of a generally U-shaped structure lying in a plane, and which is sized to fit neatly into the rectangular shape of the faceplate 11 as shown. Once the support frame 18 is inserted into contact with the faceplate 11, it may be held in position by male detents 56 in the form of pins which fit into mating female detents 58 in the form of holes, wherein the male and female detents may be located opposite each other on the support frame and the faceplate.

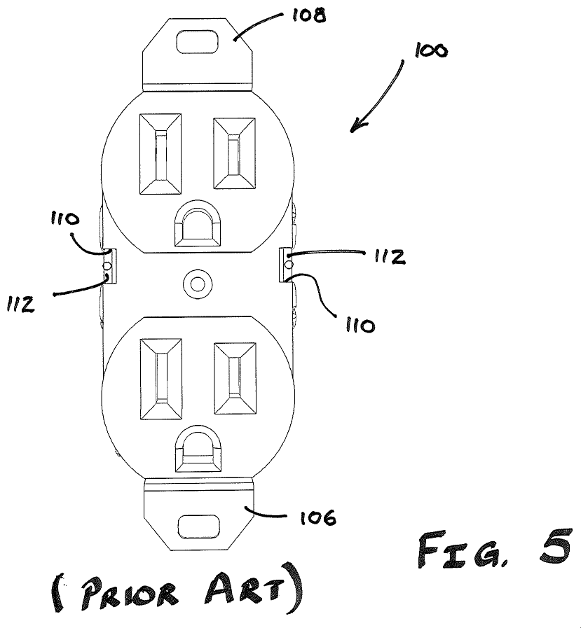

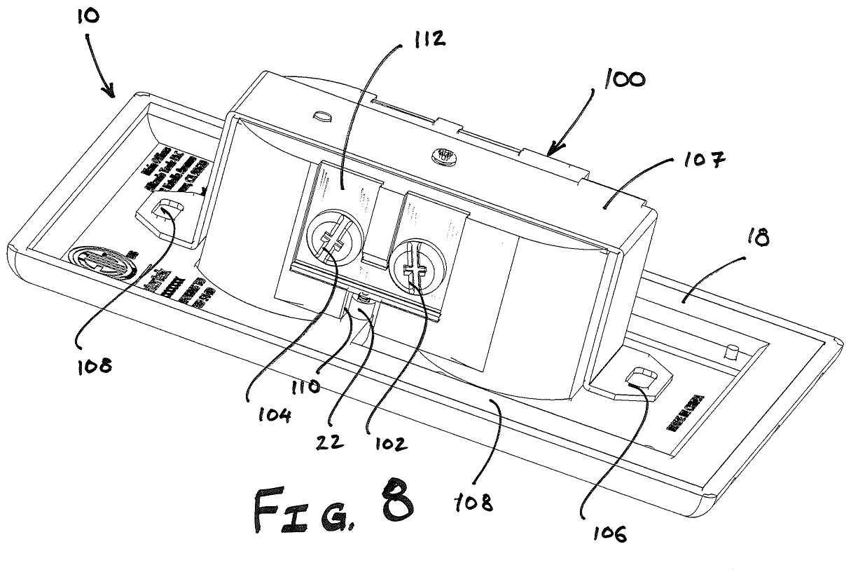

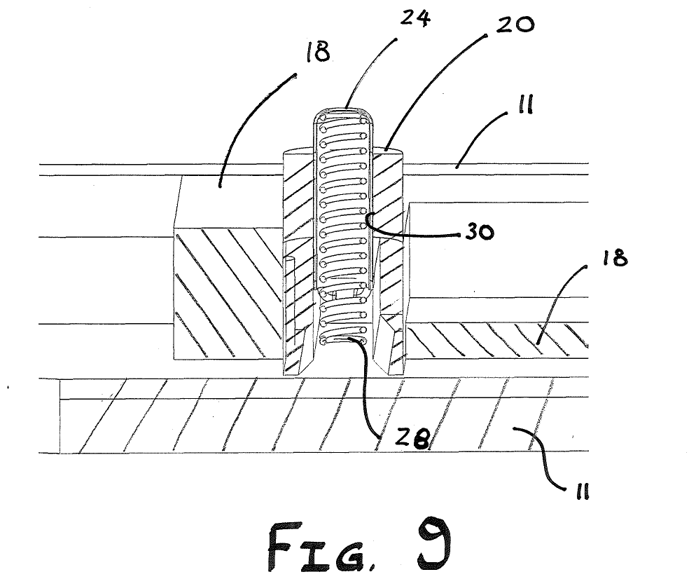

The support frame 18 further includes receptor flanges 20, 22 which may extend distally and perpendicular to the plane of the support frame. Each receptor flange 20, 22 is shaped to define a hollow interior chamber 30 (seen in FIG. 9) sized to receive and to hold a metallic contact 24, 26. Each metallic contact may be shaped with a hollow cylindrical shape, and sized to slide freely within the interior chamber 30, while permitting a distalmost end of the contact to protrude outside the chamber 30 in each flange, as seen in FIG. 9. A spring 28, 29 may be inserted within the contact 24, 26 respectively so as to provide a biased connection with a power outlet unit 100 (seen and described below with reference to FIGS. 5-6 and 8) and to receive electric power that arrives in the outlet unit 100 via terminal screws 102, 104 therein—when the coverplate 10 is attached to the outlet unit 100 as in FIG. 8.

With reference to FIG. 4 it will be understood how, during assembly of the coverplate 10, the contacts 24, 26 and additional elements may be attached onto the support frame 18 before the support frame is attached to the faceplate 11. Thus, each cylindrical contact 24, 26 is inserted into the chambers 30 molded into the two receptor flanges 20, 22 respectively. Once inserted, a spring 28, 29 may be inserted into the cylindrical contact 24, 26. The spring may then be connected to wires 52, 54 which are further described herein. The distalmost end of each contact protrudes outside of the chambers to facilitate a clean electric connection with the power outlet.

A strip of LEDs 50 may be attached to the support frame 18, and the LEDs may be spaced along the strip for being placed next to openings 16 in the faceplate 11. Two conductive wires 52, 54 are placed on the support frame to connect the strip of LEDs 50 to the contacts 24, 26 in each receptor flange respectively. Thus, a circuit may be formed between the contacts, extending along the wires and through the strip of LEDs. Power for the circuit is drawn from the potential difference that will be provided by electric power to the receptacle. A switch 17 may be provided for completing the circuit for powering the LEDs. A microprocessor which may be a motion sensor switch, or a photo detector switch, may be further inserted into the circuit for activating the LEDs upon sensing motion, or upon sensing nightfall. The circuit will eventually be powered by electric power received into the contacts 24, 26 via the power outlet 100 as described herein below with reference to FIGS. 5, 6, and 8.

During assembly, after the contacts and springs are inserted into the flanges, the support frame 18 is pressed down onto the faceplate 11, so that the pins 56 are inserted into the holes 58. The contacts 20, 24 are neatly captured and enclosed within the chambers 30, so that only a small distalmost portion of the contacts protrude outwardly through apertures in the chambers 30 for connection to the outlet 100 as shown in FIG. 8.

The resulting faceplate 10 is easy to assemble, and it has a high degree of protection against contact to a live component by a workman installing the faceplate onto a power outlet as shown in FIG. 8. It will be appreciated that, apart from the contacts, and the other electronic systems described, the coverplate and the support plate are formed from a moldable polymer that is not conductive.

To describe how the coverplate 10 is used in practice, it is necessary to describe the outlet receptacle with which the coverplate is designed to engage. FIGS. 5 and 6 show an example of a known receptacle 100 that may be used in conjunction with the coverplate 10. The receptacle includes a bracket 107 with end pieces 106, 108 configured with apertures for affixing to a wall box (not shown).

In recent years, a modification has been made to standard receptacles to allow electricians to check, without removing the receptacle from the wall box, whether power is running through the wiring of the receptacle. This modification is to include an exposed slot 110 which runs from the front of the receptacle to a point where the slot intersects with a conductive clip 112 that joins the first power screw 102 to the second power screw 104. (The screws are the points of contact, at which power arrives into the receptacle from electric wires extending from the wall into the box behind the receptacle.) The electrician testing the receptacle for power supply may simply insert his power detection tool from the front face of the receptacle and down the slot 110 until the tool touches the clip 112. If the clip is receiving power from the screws, the tool will light up and show that the receptacle is receiving electric power.

This slot 110 provides a point of entry and contact, directly from the front of the receptacle and down through slot 110 to the clip 112. As seen in FIG. 8, once the coverplate 10 is attached to the receptacle, the two flanges 20, 22 are configured to extend down at least partially within the slot 110 until the contacts 24, 26 each make contact with the respective clip 112 on each side of the receptacle. Because the clips on each side of the receptacle are connected to the screws receiving external power, there is a potential difference between the first contact 24 and the second contact 26. This potential difference is then utilized to power the circuit containing the strip of LEDs 50, switches, and sensors.

Thus, in use, the coverplate 10 is placed against the receptacle 100 so that the flanges 20, 22 line up with the exposed slots 110 on each side of the receptacle. The flanges are gently pushed distally, so that the contacts 24, 26 are forced, against the bias of the springs 28, 29, into contact with the clips 112 which are under a potential difference across the power outlet 100. (FIG. 8.) The coverplate is then screwed into a secure position on the receptacle. Thus, power is drawn from the clips 112, and an electric current flows around the circuit provided by the wires 52, 54 and the electrical load 50, thus lighting the LEDs in the load, or whatever form the load takes.

The present system and method has the advantage of reducing the possibility of the contacts forming a short circuit with any other live wire, or the wall box which often will be metal. The prior art, in which clips are lengthy and extend backwards towards the metal wall box suffers from a disadvantage because the length of the clips in the prior art, which are designed to reach all the way back to the screws in a power receptacle, increases the likelihood of making contact with conductive material in the box. The present invention eliminates the need for lengthy clip elements for receiving power from the standard screws of a receptacle, and instead obtains power from the clips 112 which join the screws together, and which are located much closer to the faceplate 11 of the coverplate 10.

Accordingly, there is described a novel system and method that addresses needs in the art. The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

I claim:

1. An active coverplate comprising:
a face plate having a proximal surface and a distal surface;
an electrical load;
a flange extending distally away from the face plate, wherein the flange comprises:
a contact having a distalmost end;
a housing defining a hollow interior and sized to receive the contact such that the distalmost end is exposed outside the housing for making electrical connection with a power supply of a receptacle body;
wherein the contact is free to slide distally and, alternatingly, proximally within the housing; and
an electrical connection between the contact and the electrical load.

2. The active coverplate of claim 1, wherein a spring is positioned in the housing to bias the contact distally.

3. The active coverplate of claim 3, wherein the contact is a cylinder, and the spring is positioned within the cylinder.

4. The active coverplate of claim 1, further comprising:
a support frame attachable to the face plate, wherein the flange is a molded feature of the support frame.
